(19) United States
(12) Patent Application Publication
(10) Pub. No.: US 2023/0030791 A1
(43) Pub. Date: Feb. 2, 2023

(54) INFORMATION PROCESSING DEVICE, INFORMATION PROCESSING METHOD, AUTONOMOUS TRAVELING ROBOT DEVICE, AND STORAGE MEDIUM

(71) Applicant: CANON KABUSHIKI KAISHA, Tokyo (JP)

(72) Inventors: Sonoko Miyatani, Tokyo (JP); Masakazu Fujiki, Kanagawa (JP)

(21) Appl. No.: 17/869,907

(22) Filed: Jul. 21, 2022

(30) Foreign Application Priority Data
Jul. 29, 2021 (JP) 2021-124647

(51) Int. Cl. G05D 1/02; G01C 21/00

(52) U.S. Cl. CPC G05D 1/0214; G05D 1/0253; G01C 21/3837; G05D 2201/0216

(57) ABSTRACT

An information processing device that can show an area in which reliable autonomous traveling is possible acquires history information of a position/orientation of a moving body estimated based on a captured image from a camera mounted on the moving body, acquires obstacle arrangement information indicating an arrangement of obstacles in a space where the moving body moves, acquires autonomous traveling possibility information indicating an area in which a setting for causing the moving body to autonomously travel is possible based on the history information, and generates a map image showing the arrangement of obstacles and the area in which autonomous traveling is possible based on the obstacle arrangement information and the autonomous traveling possibility information.

### BACKGROUND OF THE INVENTION

### Field of the Invention

The present invention relates to an information processing device, an information processing method, an autonomous traveling robot device, and a storage medium that process the position/orientation of a moving body.

### Description of the Related Art

To automatically move a moving body such as a conveyor vehicle (for example, an automated guided vehicle (AGV)) in an environment such as a factory or a distribution warehouse, it is necessary to set a travel path in advance. Methods of setting an optimum path include a method of setting a movement path which passes through points with high GPS positioning accuracy as in Japanese Patent Laid-Open No. 2015-34775.

A simultaneous localization and mapping (SLAM) technique using captured images from a camera is known as a method of measuring the position/orientation of a moving body. SLAM simultaneously performs a process of generating a map used for position/orientation measurement and a position/orientation measurement process using the map in parallel. A method involving key frames and bundle adjustment in SLAM is described in the literature “Raul Mur-Artal, et. al, ORB-SLAM: A Versatile and Accurate Monocular SLAM System. IEEE Transactions on Robotics, 2015.”

For automatic traveling (autonomous traveling) of a moving body using the SLAM technique, it is necessary to set a path where the position/orientation of the moving body can be reliably measured. However, even if the method of Japanese Patent Laid-Open No. 2015-34775 is used, it may not be possible to set a path where the position/orientation of the moving body can be reliably measured although the position information is used. Therefore, an object of the present invention is to provide an information processing device that can show an area in which reliable automatic traveling (autonomous traveling) is possible.

### SUMMARY OF THE INVENTION

An information processing device according to an aspect of the present invention includes at least one processor or circuit configured to function as a history acquisition unit configured to acquire history information of a position/orientation of a moving body estimated based on a captured image from a camera mounted on the moving body, an arrangement information acquisition unit configured to acquire obstacle arrangement information indicating an arrangement of obstacles in a space where the moving body moves, an autonomous traveling possibility information acquisition unit configured to acquire autonomous traveling possibility information indicating an area in which a setting for causing the moving body to autonomously travel is possible based on the history information acquired by the history acquisition unit, and a map image generation unit configured to generate a map image showing the arrangement of obstacles and the area in which autonomous traveling is possible based on the obstacle arrangement information and the autonomous traveling possibility information.

Further features of the present invention will become apparent from the following description of embodiments with reference to the attached drawings.

### BRIEF DESCRIPTION OF THE DRAWINGS

FIG. 1 is a functional block diagram showing an exemplary configuration of a moving body including an information processing device according to a first embodiment of the present invention.

FIG. 2 is a hardware configuration diagram of an information processing device 101 of the first embodiment.

FIG. 3 is a flowchart showing processing executed by the information processing device according to the first embodiment.

FIG. 4 is a diagram showing an example of a CG image showing automatic traveling possibility information generated in the first embodiment.

FIG. 5 is a diagram showing an example of an image in which a CG image showing automatic traveling possibility information is superimposed on an obstacle arrangement image.

FIG. 6 is a functional block diagram showing an exemplary configuration of an information processing device according to a fourth embodiment.

FIG. 7 is a flowchart showing a processing procedure according to the fourth embodiment.

FIG. 8 is a diagram showing an example of a path search result according to the fourth embodiment.

### DESCRIPTION OF THE EMBODIMENTS

Hereinafter, with reference to the accompanying drawings, favorable modes of the present invention will be described using embodiments. In each diagram, the same reference signs are applied to the same members or elements and duplicate description will be omitted or simplified.

### First Embodiment

In the automatic traveling of the moving body, position/orientation measurement of a moving body is performed based on a map for position/orientation measurement and a captured image from a camera mounted on the moving body. To measure the position/orientation, it is necessary for the moving body to travel in the vicinity of a position and orientation measured at the time of generating the map for position/orientation measurement. Therefore, in a first embodiment, information regarding not only the position but also the orientation is used for automatic traveling (autonomous traveling). In the following embodiments, automatic traveling is used in the same meaning as autonomous traveling.

Here, the orientation of the moving body refers to the advancing direction (traveling direction) of the moving body. In the first embodiment, it is assumed that one camera is mounted on the moving body and captures a predetermined angle of view in the advancing direction (traveling direction) of the moving body. However, even when a plurality of cameras are mounted on the moving body, the position/orientation of the moving body has the same meaning as the position/orientation of the camera that captures the predetermined angle of view in the advancing direction of the moving body. The position/orientation of the camera that captures the predetermined angle of view in the advancing direction of the moving body may include the angles of the imaging axis (the angles of the imaging direction) such as those of roll, pitch, and yaw.

In the first embodiment, information on a position, a range, and a direction where the moving body can automatically travel and the reliability thereof are displayed together with obstacle arrangement information. This makes it possible to check the position and direction of a path where the position/orientation can be reliably measured.

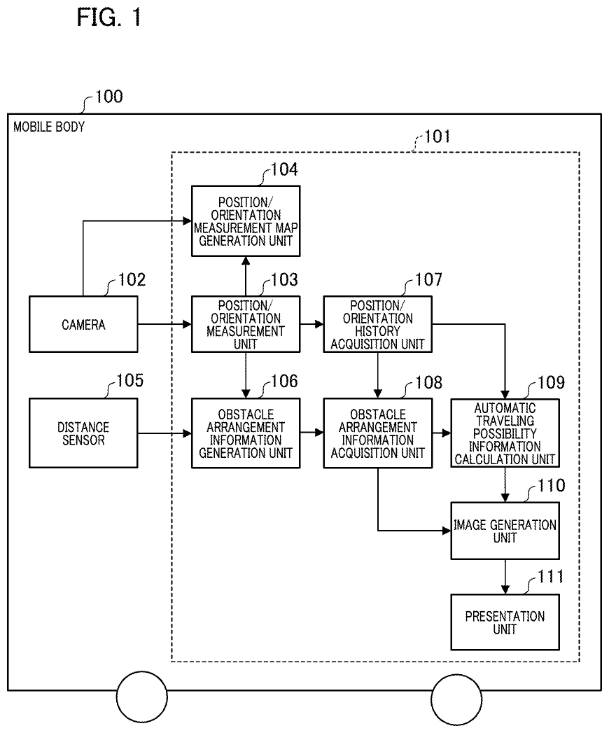

FIG. 1 is a functional block diagram showing an exemplary configuration of a moving body including an information processing device according to the first embodiment. The moving body of the first embodiment is, for example, an autonomous mobile robot (AMR) (which is an autonomous traveling robot device). Some of the functional blocks shown in FIG. 1 are realized by causing a computer included in the information processing device to execute a computer program stored in a memory which is a storage medium.

However, some or all of the functional blocks may also be realized by hardware. A dedicated circuit (ASIC), a processor (such as a reconfigurable processor or a DSP), or the like can be used as hardware. The functional blocks shown in FIG. 1 do not have to be incorporated into the same housing and the information processing device may be constructed by separate devices which are connected to each other through signal lines.

In the first embodiment, the moving body 100 is capable of autonomously traveling and includes a camera 102 which is an imaging device, a distance sensor 105, the information processing device 101, and the like. The information processing device 101 includes a position/orientation measurement unit 103, a position/orientation measurement map generation unit 104, an obstacle arrangement information generation unit 106, a position/orientation history acquisition unit 107, an obstacle arrangement information acquisition unit 108, an automatic traveling possibility information calculation unit 109, an image generation unit 110, a presentation unit 111, and the like. The information processing device does not have to be mounted inside the AMR (autonomous traveling robot device) which is the moving body.

The camera 102 is fixed to the moving body 100 and captures a predetermined angle of view in the advancing direction of the moving body 100 to generate a captured image which is an intensity image. The position/orientation measurement unit 103 calculates the position/orientation of the moving body 100 and the reliability of the position/orientation based on the captured image obtained from the camera 102. Details of the position/orientation measurement and position/orientation reliability calculation method will be described later.

The position/orientation measurement map generation unit 104 generates a map for position/orientation measurement that represents the three-dimensional positions of a group of image features, which are used during automatic traveling (autonomous traveling), based on the captured image from the camera 102 and the position/orientation of the moving body measured by the position/orientation measurement unit 103. The distance sensor 105 is fixed to the moving body 100 and acquires three-dimensional shape data of a scene which is in a predetermined direction with respect to the moving body 100. The distance sensor 105 includes a phase difference detection type of image sensor, a stereo camera, a LiDAR, a TOF sensor, or the like. The three-dimensional shape data includes the coordinate values of a three-dimensional point group.

The obstacle arrangement information generation unit 106 generates information indicating the arrangement of obstacles in the space where the moving body moves. Specifically, the obstacle arrangement information generation unit 106 generates an image showing the arrangement of obstacles (an obstacle arrangement image). Here, it is assumed that the obstacle arrangement image is obtained by orthographically projecting the three-dimensional shape data acquired by the distance sensor 105 onto a two-dimensional plane corresponding to a position which is at a predetermined height from a floor surface, after subjecting it to synthesis based on the position/orientation of the moving body measured by the position/orientation measurement unit 103, and further converting the projected image into an image of a predetermined size.

The conversion into an image of a predetermined size is performed by translating and reducing the projected image such that the entirety of the point group orthographically projected onto the plane falls within the predetermined image size and setting the pixel values of pixel positions corresponding to the positions of the point group to 255 and setting those of pixel positions not corresponding to the positions of the point group to 0. The position/orientation history acquisition unit (the history acquisition unit) 107 acquires position/orientation history information and position/orientation reliability history information of the moving body 100, which the position/orientation measurement unit 103 has calculated based on captured images from the camera mounted on the moving body, and measurement time information and saves the acquired information as a history.

The obstacle arrangement information acquisition unit 108 functions as an arrangement information unit that acquires obstacle arrangement information generated by the obstacle arrangement information generation unit 106, which indicates the arrangement of obstacles in the space where the moving body moves. The automatic traveling possibility information calculation unit 109 functions as an autonomous traveling possibility information acquisition unit that acquires automatic traveling possibility information indicating an area and a direction in which a setting for causing the moving body to autonomously travel is possible based on the history information acquired by the position/orientation history acquisition unit 107. The automatic traveling possibility information includes a position, a traveling direction, a range, and the reliability of the position/orientation measurement of the moving body. A method of calculating this automatic traveling possibility information will be described later.

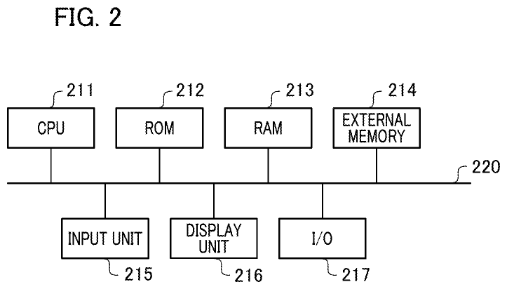

The image generation unit 110 creates a CG image showing the position, the traveling direction, the range, and the reliability calculated by the automatic traveling possibility information calculation unit 109 and generates an image, in which the CG image is superimposed on an image showing the obstacle arrangement status acquired by the obstacle arrangement information acquisition unit 108, as a map. Here, the image generation unit 110 functions as a map image generation unit that generates a map image showing an arrangement of obstacles and an area and a direction in which the moving body can automatically travel based on the obstacle arrangement information and the automatic traveling possibility information (autonomous traveling possibility information). The presentation unit 111 sends the image generated by the image generation unit 110 to the display unit 216 of FIG. 2 to present the image to a worker (user) responsible for creating an obstacle arrangement map. That is, the presentation unit 111 functions as a display control unit that controls the display of the map image.

FIG. 2 is a hardware configuration diagram of the information processing device 101 of the first embodiment. Reference numeral 211 denotes a CPU as a computer which controls various devices connected to a system bus 220. Reference numeral 212 denotes a ROM which stores a BIOS program and a boot program. Reference numeral 213 denotes a RAM which is used as a main storage device of the CPU 211.

Reference numeral 214 denotes an external memory which stores a computer program processed by the information processing device 101. An input unit 215 is a keyboard, a mouse, a robot controller, or the like and performs processing relating to input of information or the like. The display unit 216 outputs calculation results of the information processing device 101 to a display device according to an instruction from the CPU 211. The display device may be of any type such as a liquid crystal display device, a projector, or an LED indicator. Reference numeral 217 denotes an I/O interface through which the camera 102 and the distance sensor 105 are connected to the information processing device 101.

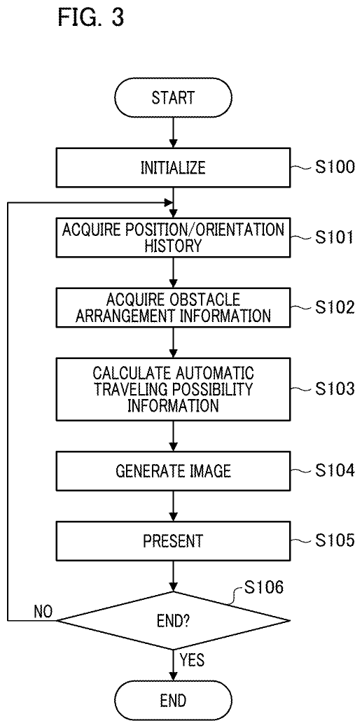

FIG. 3 is a flowchart showing processing executed by the information processing device according to the first embodiment. The processing steps include an initialization step S100, a position/orientation history acquisition step S101, an obstacle arrangement information acquisition step S102, an automatic traveling possibility information calculation step S103, an image generation step S104, a presentation step S105, an end determination step S106, and the like.

The operation of each processing step in FIG. 3 is performed by the computer in the information processing device 101 executing a computer program stored in the memory. Each processing step will be described in detail below. In step S100, initialization is performed. Specifically, for example, a set value of an allowable amount of position deviation held by an external storage device present on a network is read.

In step S101 (a history acquisition step), the position/orientation information and the position/orientation reliability information of the moving body 100 measured by the position/orientation measurement unit 103 and the measurement time information are acquired. In step S102 (an arrangement information acquisition step), an obstacle arrangement image is acquired as obstacle arrangement information indicating the arrangement of obstacles.

In step S103 (an autonomous traveling possibility information calculation step), automatic traveling possibility information for specifying an area where the moving body 100 can automatically travel is calculated. The automatic traveling possibility information includes positions, traveling directions, ranges, and reliabilities. A position is that of the moving body 100 acquired by the position/orientation history acquisition unit 107. A traveling direction is a direction in which positions of the moving body 100 are connected in chronological order. When the moving body 100 is moving forward, the advancing direction is a direction in which positions of the moving body 100 are connected in increasing order of time, and when the moving body 100 is moving backward, the advancing direction is a direction in which positions of the moving body 100 are connected in descending order of time. A range is that in which the position/orientation of the moving body 100 can be reliably measured.

In this way, the automatic traveling possibility information calculation unit 109 calculates a direction in which the position acquired by the position/orientation history acquisition unit 107 changes in the order of the position/orientation measurement time as a direction in which the moving body 100 can automatically travel. A range in which the position/orientation can be measured is the area of a circle which is centered on the position of the moving body 100 acquired in step S101 and has the allowable amount of position deviation as a radius. That is, the area where the moving body 100 can automatically travel is within a predetermined distance from the position acquired by the position/orientation history acquisition unit 107. The reliability will be described later.

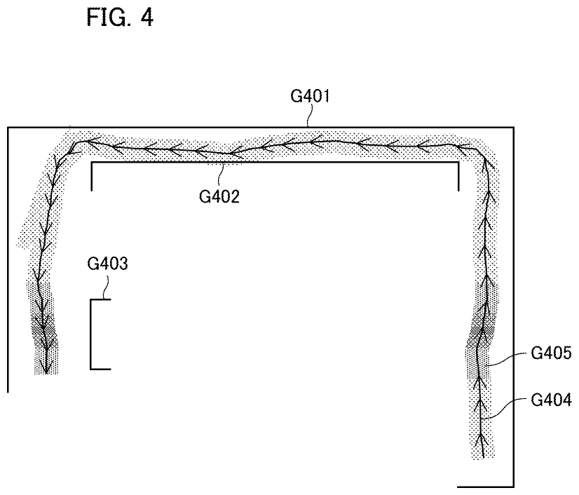

In step S104 (the map image generation step), a CG image showing the automatic traveling possibility information calculated in step S103 is generated and a map image, in which the CG image is superimposed on the obstacle arrangement image acquired in step S102, is generated. In step S105, the image generated in step S104 is displayed on the display unit 216. FIG. 4 is a diagram showing an example of a CG image showing automatic traveling possibility information generated in the first embodiment. In FIG. 4, solid lines G401, G402, and G403 indicate obstacles and an area sandwiched between the solid lines G401 and G402 and an area sandwiched between the solid lines G401 and G403 are passages. The line of an arrowed line G404 indicates positions where the moving body can travel and the direction of the arrow indicates a direction in which the moving body can travel.

A hatched area G405 in the background of the arrowed line is an area where the moving body can reliably travel and the density of hatching indicates the reliability. The denser the hatching, the higher the reliability. In step S106, the worker (user) responsible for creating an obstacle arrangement map checks the image displayed in step S105 and decides whether or not to end the series of processing of FIG. 3. If the worker decides not to end the process, the process returns to step S100. If the worker decides to end the process, the process of FIG. 3 ends.

The map for position/orientation measurement generated by the position/orientation measurement map generation unit 104 specifically includes a captured image, a position/orientation of the camera at the time of image capturing, two-dimensional positions in the captured image of image features detected from the captured image, and three-dimensional positions of the image features. Image features are feature points which indicate geometric structures such as corners in the image. A set of a captured image, a position/orientation at the time of image capturing, image features detected from the captured image, and three-dimensional positions of the features is referred to as a key frame.

The position/orientation measurement performed by the position/orientation measurement unit 103 involves performing bundle adjustment and estimating the position/orientation of the moving body. In bundle adjustment, the sum of differences (a residual error) between projection points that are the projections of the three-dimensional positions of image features held by the position/orientation measurement map generation unit 104 onto a predetermined two-dimensional area corresponding to the key frame and the positions of image features detected from a captured image during automatic traveling is calculated. Then, a position/orientation of the camera which minimizes the residual error is measured. The residual error is also used in the calculation of reliability which will be described later. A description of examples of the method involving key frames and bundle adjustment is omitted here since its detailed description is included in “Raul Mur-Artal, et. al, ORB-SLAM: A Versatile and Accurate Monocular SLAM System. IEEE Transactions on Robotics, 2015.”

The reliability of the position/orientation measurement is calculated based on a residual error obtained when the position/orientation measurement unit 103 has measured the position/orientation. Specifically, the smaller the residual error, the higher the reliability, and the larger the residual error, the lower the reliability. For example, the reliability is a value inversely proportional to the square of the residual error. That is, the automatic traveling possibility information calculation unit 109 calculates the reliability of the position/orientation measurement of the moving body based on history information of the moving body.

Further, the reliability is calculated based on the degree of agreement between an image feature detected from the captured image in the area where the moving body can automatically travel and a plurality of image features detected from a captured image used to calculate history information of the position/orientation. Thereby, according to the first embodiment, it is possible to display the position and direction of a path where the position and orientation can be reliably measured.

Although it is assumed above that the obstacle arrangement information is an image, it only needs to indicate the arrangement of obstacles and is not limited to an image. For example, the obstacle arrangement information may be represented by a three-dimensional point group or an occupancy grid map. The occupancy grid map is a map in which a scene is divided into grid cells and each grid cell holds the probability that an obstacle is present in the grid cell.

Also, anything can be used as the reliability of the position/orientation measurement as long as it can express the reliability of the position/orientation. For example, when measuring a position/orientation, the position/orientation measurement unit 103 may calculate the reliability of the position/orientation measurement based on the number of image features detected from a captured image during automatic traveling or the distribution of the positions of the image features. It can be determined that the greater the number of feature points or the wider the spatial distribution of feature points, the higher the reliability. On the contrary, it can be determined that the smaller the number of feature points or the more biased the spatial distribution of feature points, the lower the reliability. As described above, in the first embodiment, the area where the moving body can automatically travel is calculated based on the number of image features detected from a captured image used to calculate the history information of the position/orientation.

In step S103 described above, the range in which the position/orientation can be measured is a circular shape, but the range is not limited to a circular shape and may be an elliptical shape, a rectangular shape, or the like. Also, although the case where the position, the direction, the range, and the reliability are all displayed has been described above, at least either the position or the range and the direction may be displayed or only the position and the direction may be displayed. Alternatively, only the direction, the range, and the reliability may be displayed. In any case, the first embodiment has an advantage that path setting of the moving body is very easy.

### Second Embodiment

In the first embodiment, a range of positions of the camera in which image features held by the map for position/orientation measurement are observable may be set as the range in which the moving body can automatically travel. That is, in a second embodiment, first, a plurality of positions of a virtual camera are set at predetermined intervals (of L) in the vicinity of the position of the camera at the time of image capturing held by the map for position/orientation measurement. Next, it is determined whether or not the image features held by the map for position/orientation measurement are observable from each of the set positions of the virtual camera.

Specifically, three-dimensional image features held by the map for position/orientation measurement are projected onto a two-dimensional image plane based on the position of the camera and the orientation of the camera at the time of image capturing held by the map for position/orientation measurement and it is determined whether or not the image features in the projected image are observable. It is determined that the image features are observable when the positions of the projected image features in the image are within the captured image area of the camera, that is, within the angle of view of the camera.

When the number of image features that are determined to be observable is equal to or greater than a preset threshold, a circular area centered on each position of the camera and having a diameter of L is set as a range in which the moving body can automatically travel. When the number of image features that are determined to be observable is less than the threshold, a circular area centered on each position of the camera and having a diameter of L is set as a range in which the moving body cannot automatically travel.

The reliability included in the automatic traveling possibility information may be calculated based on the number and distribution of observable image features calculated by the above method instead of using the reliability acquired by the position/orientation history acquisition unit. In this case, the greater the number of feature points or the wider the distribution of feature points, the higher the reliability. On the contrary, the smaller the number of feature points or the more biased the spatial distribution of feature points, the lower the reliability.

### Third Embodiment

While a range of positions where the moving body can automatically travel is calculated as a range where the moving body can automatically travel in the first and second embodiments, a range of orientations of the moving body with which the moving body can automatically travel is calculated as a range of orientations with which the moving body can automatically travel and displayed on a screen in a third embodiment. In a calculation method, first, a plurality of orientations of a virtual camera are set for each position of the camera at the time of image capturing.

The orientation of the camera is expressed by a roll, pitch, and yaw and a plurality of rotation angles for each of roll, pitch, and yaw are set at predetermined rotation angle intervals (of D). Then, for each set orientation, whether or not image features held by the map for position/orientation measurement are observable is determined using the method described in the second embodiment. When the number of image features that are determined to be observable is equal to or greater than a preset threshold, a range of rotation angles of −D/2 to +D/2 centered on the orientation for each of roll, pitch, and yaw is set as a range of orientations with which the moving body can automatically travel. When the number of image features that are determined to be observable is less than the threshold, a range of rotation angles of −D/2 to +D/2 centered on the orientation for each of roll, pitch, and yaw is set as a range of orientations with which the moving body cannot automatically travel.

The range of orientations may be limited to a predetermined range that has been set in advance. In this case, a predetermined range of orientations centered on the orientation of the camera at the time of image capturing is set as a range of orientations with which the moving body can automatically travel. While a range of orientations is calculated as a range in which the moving body can automatically travel in the above description, a pair of a range of positions and a range of orientations may be calculated as a range in which the moving body can automatically travel. In this case, a range of orientations described in the third embodiment is calculated at each of the plurality of positions of the virtual camera described in the second embodiment.

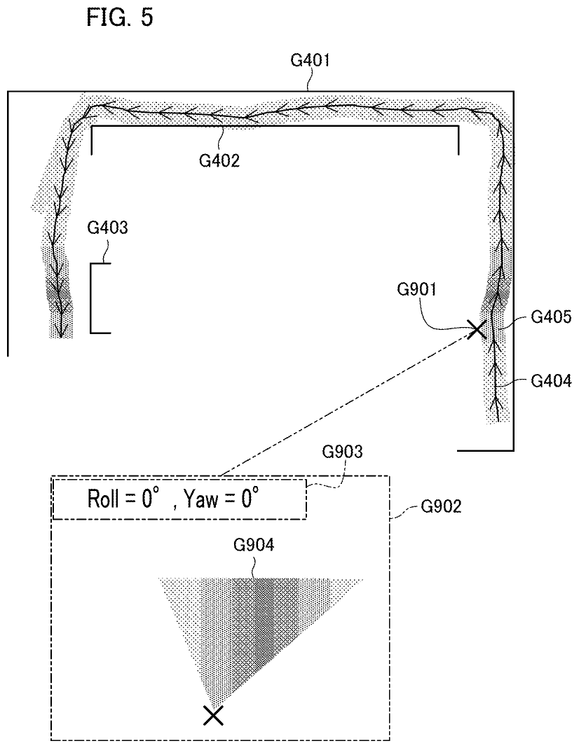

FIG. 5 is a diagram showing an example of an image in which a CG image showing automatic traveling possibility information is superimposed on an obstacle arrangement image. That is, FIG. 5 shows an example of an image in which a CG image showing automatic traveling possibility information is superimposed on an obstacle arrangement image generated in step S104 when a range in which the moving body can automatically travel is set as a range of positions and orientations. G401 to G405 denote the same as those described in the first embodiment. G901 denotes a position that the user has designated via the input unit 215 within a range in which the moving body can automatically travel.

G902 denotes a GUI indicating a range of orientations with which the moving body can automatically travel at the point G901. G903 denotes two rotation angles (of roll and yaw) that the user has designated via the input unit 215 among the three rotation angles of roll, pitch, and yaw. G904 denotes a range of pitches where the moving body can automatically travel at the designated rotation angles of roll and yaw. In the GUI G902, the density of hatching indicates the reliability which increases as the density of the hatching increases.

### Fourth Embodiment

In a fourth embodiment, a path through which the moving body can automatically travel is further searched for based on automatic traveling possibility information and obstacle arrangement information. It is assumed that a start point, waypoints, and a destination point of a path are positions predetermined by the user.

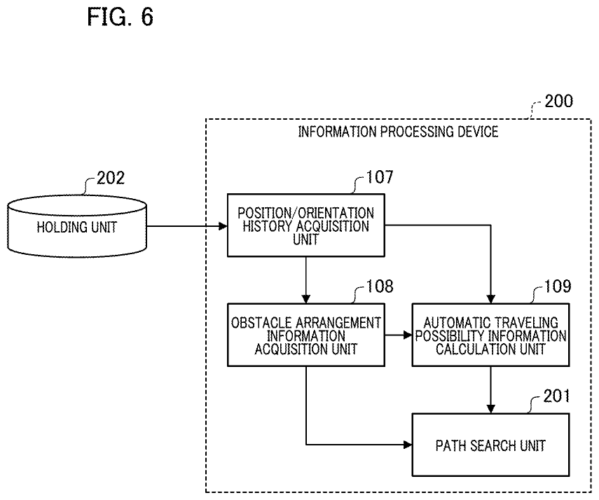

FIG. 6 is a functional block diagram showing an exemplary configuration of an information processing device according to the fourth embodiment. Some of the functional blocks shown in FIG. 6 are realized by causing a computer included in the information processing device to execute a computer program stored in a memory which is a storage medium. However, some or all of the functional blocks may also be realized by hardware. A dedicated circuit (ASIC), a processor (such as a reconfigurable processor or a DSP), or the like can be used as hardware.

The functional blocks shown in FIG. 6 do not have to be incorporated into the same housing and the information processing device may be constructed by separate devices which are connected to each other through signal lines. In FIG. 6, an information processing device 200 includes a position/orientation history acquisition unit 107, an obstacle arrangement information acquisition unit 108, an automatic traveling possibility information calculation unit 109, and a path search unit 201 and is connected to a holding unit 202. Although not shown in FIG. 6, the image generation unit 110 and the presentation unit 111 in FIG. 1 may also be provided in the information processing device 200 and the presentation unit 111 may present (display an image of) a path found by the path search unit 201 via the image generation unit 110.

The position/orientation history acquisition unit 107 acquires a position/orientation history. While the position/orientation history is acquired from the position/orientation measurement unit 103 in the first embodiment, it is acquired from the holding unit 202 in the fourth embodiment. The position/orientation history is stored with a history of position/orientation information, position/orientation reliability information, and measurement time information, and so on similar to that described in the first embodiment.

The obstacle arrangement information acquisition unit 108 acquires obstacle arrangement information. While the obstacle arrangement information is acquired from the obstacle arrangement information generation unit 106 in the first embodiment, it is acquired from the holding unit 202 in the fourth embodiment. The obstacle arrangement information is an obstacle arrangement image showing the obstacle arrangement status, similar to that described in the first embodiment.

The automatic traveling possibility information calculation unit 109 is similar to that described in the first embodiment. The path search unit 201 searches for a path through which the moving body can automatically travel based on the position/orientation history and the obstacle arrangement information. The holding unit 202 holds the position/orientation measurement history and the obstacle arrangement information.

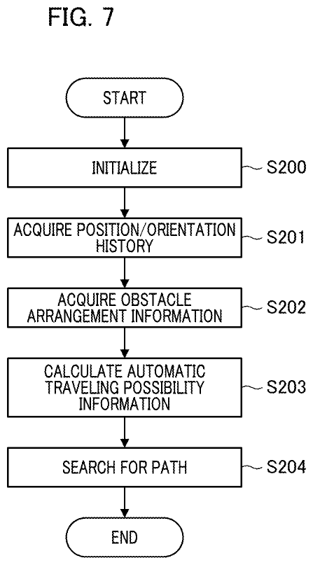

FIG. 7 is a flowchart showing a processing procedure according to the fourth embodiment. The processing steps include an initialization step S200, a position/orientation history acquisition step S201, an obstacle arrangement information acquisition step S202, an automatic traveling possibility information calculation (an autonomous traveling possibility information acquisition) step S203, and a path search step S204. The operation of each processing step in FIG. 7 is performed by the computer in the information processing device 200 executing a computer program stored in the memory. Each processing step will be described in detail below.

In step S200, initialization is performed. Specifically, a set value of an allowable amount of position deviation held by an external storage device is read. In step S201, the position/orientation history acquisition unit 107 acquires the position/orientation, the reliability of the position/orientation, and the measurement time calculated to generate a map for position/orientation measurement of the moving body from the holding unit 202.

In step S202, obstacle arrangement information is acquired from the holding unit 202. In step S203, a position, a direction, and a range where the moving body can automatically travel and the reliability thereof, which are automatic traveling possibility information calculated by the moving body, are acquired. In step S204, the path search unit 201 searches for a path through which the moving body can automatically travel and for which a start point, waypoints, and a destination point are preset based on the obstacle arrangement information acquired in step S202 and the automatic traveling possibility information calculated in step S203. Here, step S204 functions as a path search unit (a path search step) for searching for a travel path of the moving body based on the automatic traveling possibility information and the obstacle arrangement information.

In a search method, for example, first, for each point to be passed through, a pair of points adjacent to the point to be passed through is selected from a start point, a group of waypoints, and a destination point one by one in the order of passage and a path through which the moving body can automatically travel in a section connecting the pair of points is searched for. The search is performed using a known algorithm, for example, the A-star algorithm. The A-star algorithm is an algorithm that expresses a path with nodes and searches for a shortest path from a start point to a destination point.

In the fourth embodiment, the obstacle arrangement image is divided into a plurality of grid cells and each grid cell is treated as a node. The advancing direction at each node is limited to two directions close to a direction in which the moving body can automatically travel among the eight directions of up, down, left, right, diagonally upper right, diagonally lower right, diagonally upper left, and diagonally lower left Grid cells, each including an obstacle or an area where the moving body cannot automatically travel, are set as those where the moving body cannot advance. Then, a path passing through the waypoints from the start point and reaching the destination point, which is limited to the area and direction where the moving body can automatically travel, is searched for by connecting paths between the pairs of points.

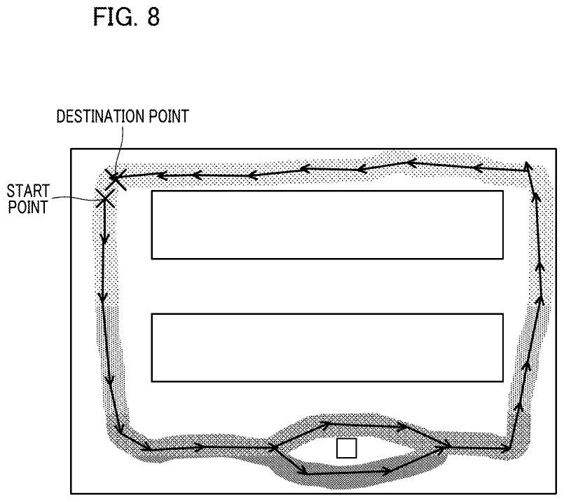

FIG. 8 is a diagram showing an example of a path search result according to the fourth embodiment. Black arrows in FIG. 8 indicate a path obtained through the search and hatching in the background of each arrow indicates the range in which the moving body can automatically travel. Thus, the presentation unit 111 which is the display control unit controls the display of the map image and the travel path of the moving body. The direction and amount of movement of the moving body 100 may be directly controlled based on the found path without performing the display. By performing the method described above, it is possible to set a path where the position/orientation can be reliably measured.

While the A-star algorithm is applied to the path search in the above description, it is sufficient if a path through which the moving body can automatically travel from the preset start point to the preset destination point can be searched for and other path search methods such as, for example, the Dijkstra method may be applied. A method of setting a start point, waypoints and a destination point in advance and searching for a path from the start point to the destination point which passes through the waypoints has also been described above. However, it is also possible to search for a path from the start point to the destination point without setting waypoints.

Although the method of setting a start point, waypoints, and a destination point in advance and searching for a path from the start point to the destination point which passes through the waypoints has been described above, an area indicating approximate locations rather than points may also be set. In this case, predetermined positions within the set area and within the range where the moving body can automatically travel, for example, positions whose reliability included in the automatic traveling possibility information is the highest, may be set as points and a path may be searched for using the method described in the fourth embodiment.

Further, in the fourth embodiment, the user may manually input and set a path through which the moving body can automatically travel based on the automatic traveling possibility information and the obstacle arrangement information. Specifically, in step 204, the user refers to the obstacle arrangement image on which the CG image showing the automatic traveling possibility information is superimposed and inputs waypoints and the order of passage via the input unit 215. Thus, it is possible to set a path that passes through the input waypoints in the order of passage from the predetermined start point and reaches the predetermined destination point.

In addition, when the user has input waypoints and the order of passage which do not correspond to the positions or directions in which the moving body can automatically travel, for example, the user may be notified that “these are not the positions or directions in which the moving body can automatically travel.” Similar to waypoints, a start point and a destination point may be input by the user via the input unit 215.

A path through which the moving body can automatically travel may be searched for based only on the automatic traveling possibility information. Specifically, in step 204, only grid cells, each including an area where the moving body cannot automatically travel, are set as those where the moving body cannot advance. This makes it possible to search for a path through which the moving body can automatically travel based only on the automatic traveling possibility information.

A path through which the moving body can automatically travel may also be searched for based on a search condition for the path in addition to the automatic traveling possibility information and the obstacle arrangement information. Specifically, a reliability threshold is set as a search condition and a path having a higher reliability than the threshold is searched for. This makes it possible to search for a path where position/orientation measurement can be more reliably performed.

For example, the path search unit 201 of FIG. 6 searches paths through which the moving body can automatically travel based on the automatic traveling possibility information and the obstacle arrangement information and also searches paths based on a predetermined reliability as a search condition.

Then, in step S204 in FIG. 7, a path through which the moving body can automatically travel is searched for based on the obstacle arrangement information acquired in step S202, the automatic traveling possibility information calculated in step S203, and the reliability threshold which is a search condition. It is assumed that the obstacle arrangement information is an image (an obstacle arrangement image). That is, first, for each point to be passed through, a pair of points adjacent to the point to be passed through is selected from a start point, a group of waypoints, and a destination point one by one in the order of passage and all paths through which the moving body can automatically travel in a section connecting the pair of points are searched for. For example, an existing method called Breadth-first search is used as a full search method.

Here, the obstacle arrangement image is divided into a plurality of grid cells and each grid cell is treated as a node and all paths between nodes including the points are searched for. The advancing direction at each node is limited to two directions close to a direction in which the moving body can automatically travel among the eight directions of up, down, left, right, diagonally upper right, diagonally lower right, diagonally upper left, and diagonally lower left. Further, not only grid cells, each including an obstacle or an area where the moving body cannot automatically travel, but also areas where the reliability is lower than a predetermined threshold are set as those where the moving body cannot advance.

Then, a path passing through the waypoints from the start point and reaching the destination point, which is limited to the area and direction where the moving body can automatically travel and in which the reliability is higher than the predetermined threshold, is searched for by connecting paths between the pairs of points. By doing so, it is possible to search for a path passing through the waypoints from the start point and reaching the destination point, which is limited to the area and direction where the moving body can automatically travel and in which the reliability is higher than the threshold.

If there is no path satisfying the search condition in the path search described in the path search step S204 above, a notification of this fact may be provided. That is, a notification unit may be provided to notify the user when there is no path through which the moving body can automatically travel. Although a method of searching for a path through which the moving body can automatically travel through positions where the reliability is higher than the threshold has been described above, a path through which the moving body can automatically travel with an average reliability higher than a threshold may also be searched for.

In this case, paths are searched for assuming that only grid cells, each including an obstacle or an area where the moving body cannot automatically travel, are those where the moving body cannot advance, and an average reliability is obtained based on reliability values on each path. Then, a path whose average reliability is higher than a reliability threshold is extracted as a path through which the moving body can automatically travel and which has a reliability higher than the threshold.

### Fifth Embodiment

In step S204 of the above embodiment, a method of searching for a path passing through the waypoints from the start point and reaching the destination point, which is limited to the area and direction where the moving body can automatically travel, has been described. In a fifth embodiment, a plurality of paths passing through waypoints from a start point and reaching a destination point, without being limited to the area and direction in which the moving body can automatically travel, are searched for and a path which is limited to the area and direction in which the moving body can automatically travel is selected from the plurality of found paths. Hereinafter, the processing of step S204 in the fifth embodiment will be described.

In step S204, first, a plurality of paths passing through waypoints from a start point and reaching a destination point, without being limited to the area and direction in which the moving body can automatically travel, are searched for. Specifically, the same processing as in step S204 of the second and third embodiments is performed assuming that the advancing directions at each node are the eight directions of up, down, left, right, diagonally upper right, diagonally lower right, diagonally upper left, and diagonally lower left. Then, a path which is limited to the area and direction in which the moving body can automatically travel is selected from the plurality of found paths. In this way, the path search unit 201 can search for or select a path through which the moving body can automatically travel based on the reliability of the automatic traveling possibility information, the obstacle arrangement information, and the automatic traveling possibility information.

Further, in the above embodiment, the user may be allowed to arbitrarily set a path and a path of the moving body which has been arbitrarily set in advance may then be corrected such that it becomes a path through which the moving body can automatically travel based on the automatic traveling possibility information. That is, first, it is checked whether or not start and destination points of the path arbitrarily set by the user are within a range in which the moving body can automatically travel, and if the start and destination points are out of the range, they are moved such that they fall within the range. For example, each point is moved to a position on a boundary line of the range which minimizes the distance between the point and the boundary line.

Next, the same processing as in step 204 of FIG. 7 is performed to search for paths reaching the destination point from the start point, which are limited to the area and direction in which the moving body can automatically travel. Next, a path that passes near the path arbitrarily set by the user is extracted from the found paths. Specifically, a path found through the search, whose distances from its path line to the waypoints of the path arbitrarily set by the user are within a predetermined range, is extracted. The extracted path may be determined to be a corrected path.

The AMR (autonomous traveling robot device) of FIG. 1 has a driving device such as a motor and an engine for causing the AMR to move (travel) and a moving direction control device for changing the moving direction of the AMR. The AMR also has a movement control unit for controlling the drive amount of the drive device and the moving direction of the moving direction control device.

The movement control unit internally includes a CPU as a computer and a memory that stores a computer program and controls, for example, the information processing device 101 by communicating with other devices and acquires position/orientation information, travel path information, and the like from the information processing device 101. The AMR is configured such that it controls the moving direction, the amount of movement, and the movement path of the AMR through the movement control unit based on a travel path found by the information processing device 101. In addition, the units in the above embodiments may include discrete electronic circuits or some or all of the units may be constructed by a processor such as an FPGA or a CPU or a computer program.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions. In addition, as a part or the whole of the control according to the embodiments, a computer program realizing the functions of the embodiments described above may be supplied to the information processing device through a network or various storage media. Then, a computer (or a CPU, an MPU, or the like) of the information processing device may be configured to read and execute the program. In such a case, the program and the storage medium storing the program configure the present invention.

This application claims the benefit of Japanese Patent Application No. 2021-124647 filed on Jul. 29, 2021, which is hereby incorporated by reference herein in its entirety.

What is claimed is:

1. An information processing device comprising at least one processor or circuit configured to function as:
a history acquisition unit configured to acquire history information of a position/orientation of a moving body estimated based on a captured image from a camera mounted on the moving body;
an arrangement information acquisition unit configured to acquire obstacle arrangement information indicating an arrangement of obstacles in a space where the moving body moves;
an autonomous traveling possibility information acquisition unit configured to acquire autonomous traveling possibility information indicating an area in which a setting for causing the moving body to autonomously travel is possible based on the history information acquired by the history acquisition unit; and
a map image generation unit configured to generate a map image showing the arrangement of obstacles and the area in which autonomous traveling is possible based on the obstacle arrangement information and the autonomous traveling possibility information.

2. The information processing device according to claim 1, wherein the autonomous traveling possibility information acquisition unit is configured to acquire the area and a direction in which autonomous traveling is possible based on the history information of the moving body.

3. The information processing device according to claim 2, wherein the map image generation unit is configured to generate the map image showing the arrangement of obstacles and the area and the direction in which autonomous traveling is possible based on the obstacle arrangement information and the autonomous traveling possibility information.

4. The information processing device according to claim 1, wherein the autonomous traveling possibility information acquisition unit is configured to calculate a reliability of position/orientation measurement of the moving body based on the history information of the moving body.

5. The information processing device according to claim 1, wherein the autonomous traveling possibility information acquisition unit is configured to calculate a direction in which a position acquired by the history acquisition unit changes in an order of position/orientation measurement time as the direction in which autonomous traveling is possible.

6. The information processing device according to claim 1, wherein the area in which autonomous traveling is possible is within a predetermined distance from a position acquired by the history acquisition unit.

7. The information processing device according to claim 1, wherein the area in which autonomous traveling is possible is calculated based on the number of image features detected from the captured image used to calculate the history information of the position/orientation.

8. The information processing device according to claim 4, wherein the reliability is calculated based on a degree of agreement between an image feature detected from a captured image in the area in which autonomous traveling is possible and a plurality of image features detected from the captured image used to calculate the history information of the position/orientation.

9. The information processing device according to claim 1, wherein the history acquisition unit is configured to acquire a reliability of the position/orientation of the moving body.

10. The information processing device according to claim 1, further comprising a display control unit configured to control display of the map image.

11. The information processing device according to claim 1, further comprising a path search unit configured to search for a travel path of the moving body based on the autonomous traveling possibility information and the obstacle arrangement information.

12. An information processing device comprising at least one processor or circuit configured to function as:
a history acquisition unit configured to acquire history information of a position/orientation of a moving body estimated based on a captured image from a camera mounted on the moving body;
an arrangement information acquisition unit configured to acquire obstacle arrangement information indicating an arrangement of obstacles in a space where the moving body moves;
an autonomous traveling possibility information acquisition unit configured to acquire autonomous traveling possibility information indicating an area in which a setting for causing the moving body to autonomously travel is possible based on the history information acquired by the history acquisition unit; and
a path search unit configured to search for a travel path of the moving body based on the autonomous traveling possibility information and the obstacle arrangement information.

13. The information processing device according to claim 12, wherein the autonomous traveling possibility information acquisition unit is configured to acquire the area and a direction in which autonomous traveling is possible based on the history information of the moving body.

14. The information processing device according to claim 12, wherein the path search unit is configured to correct a preset path of the moving body to a path through which a setting for causing the moving body to autonomously travel is possible based on the autonomous traveling possibility information.

15. The information processing device according to claim 12, wherein the path search unit is configured to search for or select a path through which a setting for causing the moving body to autonomously travel is possible based on the autonomous traveling possibility information, the obstacle arrangement information, and a reliability of the autonomous traveling possibility information.

16. The information processing device according to claim 15, further comprising a notification unit configured to notify a user when the path through which a setting for causing the moving body to autonomously travel is possible does not exist.

17. The information processing device according to claim 12, further comprising:
a map image generation unit configured to generate a map image showing the arrangement of obstacles and the area in which autonomous traveling is possible based on the obstacle arrangement information and the autonomous traveling possibility information; and
a display control unit configured to control display of the map image and the travel path of the moving body.

18. An information processing method comprising:
acquiring history information of a position/orientation of a moving body estimated based on a captured image from a camera mounted on the moving body;
acquiring obstacle arrangement information indicating an arrangement of obstacles in a space where the moving body moves;
acquiring autonomous traveling possibility information indicating an area in which a setting for causing the moving body to autonomously travel is possible based on the history information acquired in the history acquisition; and
generating a map image showing the arrangement of obstacles and the area in which autonomous traveling is possible based on the obstacle arrangement information and the autonomous traveling possibility information.

19. An information processing method comprising:
acquiring history information of a position/orientation of a moving body estimated based on a captured image from a camera mounted on the moving body;
acquiring obstacle arrangement information indicating an arrangement of obstacles in a space where the moving body moves;
acquiring autonomous traveling possibility information indicating an area in which a setting for causing the moving body to autonomously travel is possible based on the history information acquired in the history acquisition; and
searching for a travel path of the moving body based on the autonomous traveling possibility information and the obstacle arrangement information.

20. An autonomous traveling robot device comprising at least one processor or circuit configured to function as:
a history acquisition unit configured to acquire history information of a position/orientation of a moving body estimated based on a captured image from a camera mounted on the moving body;
an arrangement information acquisition unit configured to acquire obstacle arrangement information indicating an arrangement of obstacles in a space where the moving body moves;
an autonomous traveling possibility information acquisition unit configured to acquire autonomous traveling possibility information indicating an area in which a setting for causing the moving body to autonomously travel is possible based on the history information acquired by the history acquisition unit;
a path search unit configured to search for a travel path of the moving body based on the autonomous traveling possibility information and the obstacle arrangement information; and
a movement control unit configured to control movement of the moving body based on the travel path found by the path search unit.

21. A non-transitory computer-readable storage medium configured to store a computer program comprising instructions for executing the processes of:
acquiring history information of a position/orientation of a moving body estimated based on a captured image from a camera mounted on the moving body;
acquiring obstacle arrangement information indicating an arrangement of obstacles in a space where the moving body moves;
acquiring autonomous traveling possibility information indicating an area in which a setting for causing the moving body to autonomously travel is possible based on the history information acquired in the history acquisition; and
generating a map image showing the arrangement of obstacles and the area in which autonomous traveling is possible based on the obstacle arrangement information and the autonomous traveling possibility information.
